(19) United States
(12) Patent Application Publication
(10) Pub. No.: US 2011/0148765 A1
(43) Pub. Date: Jun. 23, 2011

(54) OPTICAL MOUSE SOC WITH 8-PINS

(75) Inventors: Chiao-Tung Chuang, Taoyuan County (TW); Yung-Shun Chuang, Keelung City (TW)

(73) Assignee: Sunplus Innovation Technology Inc., Hsinchu (TW)

(21) Appl. No.: 12/972,856

(22) Filed: Dec. 20, 2010

(30) Foreign Application Priority Data
Dec. 22, 2009 (TW) 98144299

(51) Int. Cl. G06F 3/033

(52) U.S. Cl. 345/166

(57) ABSTRACT

SOC (System On Chip) for optical mouse with 8-pins is provided. The SOC of the invention has three power pins for coupling a first power voltage, a second power voltage and ground voltage, a driving pin for controlling a light source, an optical sensing array for receiving reflected light, two signal pins for data exchange with a host and two IO pins. For at least five different switches of the optical mouse that receive touch controls of users, each IO pin receives and distinguishes statuses of multiple switches, such that a total pin count of the IO pins is less than a total number of switches.

This application claims the benefit of Taiwan application Serial No. 98144299, filed Dec. 22, 2009, the subject matter of which is incorporated herein by reference.

### FIELD OF THE INVENTION

The present invention relates to an optical mouse SOC with 8-pins, and more particularly, to an optical mouse SOC with 8-pins which has an integrated optical sensing array and is capable of distinguishing switch statuses of multiple buttons with two IO pins for pin count optimization.

### BACKGROUND OF THE INVENTION

Optical mouse, which constructs a user-friendly visual interface with a screen, has become one of the most important portions in human-machine interface of modern computer system. Functions of an optical mouse are implemented by optical locating and button/wheel control. Optical locating detects displacement of the optical mouse for moving a cursor on the screen. A plurality switches are installed in the optical mouse; as the user presses/clicks/rolls buttons/wheel(s) of the optical mouse, these switches are respectively triggered to change statuses in response to user touch control. As a result, the user can control the host of the computer system through the visual interface by moving the optical mouse, pressing/clicking buttons and/or rolling the wheel of the optical mouse.

In the electrical structure of an optical mouse, functionality of optical locating is implemented with an optical locating subsystem, which includes an optical sensing array for receiving reflected light of a light source, such that the optical locating subsystem compares between reflected lights to find displacement of the optical mouse. On the other hand, each button/wheel of the optical mouse has a corresponding switch with status corresponding to button pressing/clicking or wheel rolling. And a micro-controller subsystem integrates sensing result of the optical sensing array and statuses of the switches to be transmitted to the host.

In prior art optical mouse, the optical locating subsystem and the micro-controller subsystem are implemented with two chips of different functions, one specific chip has the optical sensing array and the optical locating subsystem, the other chip implements the micro-controller subsystem. Because two chips are required, circuit board connecting these two chips needs complicated and expensive routings, which also lead to higher power consumption for conquering higher routing impedance. Therefore, cost and resource consumption for manufacturing, assembling and operation this kind of prior art are high.

Under the cost consideration, another kind prior art applies SOC (System-On-a-Chip) solution, which integrates optical sensing chip and the micro-controller chip into an SOC to reduce large layout requirement of the aforementioned prior art. Please refer to FIG. 1 which illustrates a prior art chip 101 implementing electric structure of an optical mouse. The chip 101 has twelve pins, including four power pins V1 to V4, a driving pin L0, two signal pins D+ and D−, and five IO pins IOA1 to IOA5. The power pins V1 to V4 respectively couple to corresponding operation voltages, including power voltages of different magnitude and ground voltage. The signal pins D+ and D− are used to exchange data with the host (not shown); for example, as the chip 101 adopts the USB (Universal Serial Bus) interface specification to exchange data with the host, two differential signal pins D+ and D− are required. The chip 101 controls the light source of the optical mouse with the driving pin L0.

In a typical optical mouse of three buttons and a wheel, five switches are installed to receive user touch control; three of the switches respectively correspond to three buttons, as the other two switches reflect rolling statuses of the wheel. The five pins IOA1 to IOA5 are used to receive statuses of the five switches, respectively. Because the buttons/wheel can be touched/triggered simultaneously, and all possible status variation of each switch is digital, the prior chip 101 needs different IO pins mapped to different switches for distinguishing statuses of the switches according to mapping between IO pin and switch. Since each individual switch of the optical mouse need a specific independent IO pin, high pin count, not fewer than twelve, is required, and effective cost down can not be expected.

### SUMMARY OF THE INVENTION

One objective of the invention is providing an optical mouse SOC with 8-pins applied to an optical mouse which comprises a plurality of switches for receiving touch control, the optical mouse SOC comprising: a micro-controller subsystem; an optical locating subsystem providing an optical location signal to the micro-controller subsystem; a first power pin coupled to a first power voltage supplying the optical locating subsystem and the micro-controller subsystem; a second power pin coupled to a second power voltage supplying the optical locating subsystem and the micro-controller subsystem; a driving pin coupled to the optical locating subsystem for controlling a light source; two signal pins coupled to the micro-controller subsystem for providing a differential signal, with an amplitude of the second power voltage, to a host; and a first IO pin coupled to a predetermined number of the plurality of switches such that the micro-controller subsystem detects statuses of the predetermined number of the plurality of switches.

Another objective of the invention is providing an optical mouse SOC with 8-pins applied to an optical mouse which comprises a left button switch, a middle button switch, a right button switch, a first wheel switch and a second wheel switch for receiving touch control, the optical mouse SOC comprising: a micro-controller subsystem; an optical locating subsystem providing an optical location signal to the micro-controller subsystem; a first power pin coupled to a first power voltage supplying the optical locating subsystem and the micro-controller subsystem; a second power pin coupled to a second power voltage supplying the micro-controller subsystem; a driving pin coupled to the optical locating subsystem for controlling a light source; two signal pins coupled to the micro-controller subsystem for providing a differential signal, with an amplitude swinging between the first power voltage and the second power voltage, to a host; and a first IO pin with a first parallel circuit connected between the first IO pin and the first power voltage; wherein the first parallel circuit comprises a first resistor serial to the left button switch, a second resistor serial to the middle button switch, and a third resistor serial to the right button switch; the first resistor, the second resistor and the third resistor have different resistances.

Still another objective of the invention is providing an optical mouse SOC with 8-pins, applied to an optical mouse which comprises a left button switch, a middle button switch, a right button switch, a first wheel switch and a second wheel switch for receiving touch control, the optical mouse SOC comprising: a micro-controller subsystem; an optical locating subsystem providing an optical location signal to the micro-controller subsystem; a first power pin coupled to a first power voltage supplying the optical locating subsystem and the micro-controller subsystem; a second power pin coupled to a second power voltage supplying the micro-controller subsystem; a third power pin coupled to a ground voltage supplying the optical locating subsystem and the micro-controller subsystem; a driving pin coupled to the optical locating subsystem for controlling a light source; two signal pins coupled to the micro-controller subsystem for providing a differential signal, with an amplitude of the second power voltage, to a host; and a first IO pin with a parallel circuit connected between the first IO pin and the first power voltage; and a second IO pin with a common resistor connected between the second IO pin and the first IO pin, and with a common capacitor connected between the second IO pin and the ground voltage; wherein the parallel circuit comprises a first resistor serial to the left button switch, a second resistor serial to the middle button switch, a third resistor serial to the right button switch, a fourth resistor serial to the first wheel switch and a fifth resistor serial to the second wheel switch; the first resistor, the second resistor, the third resistor, the fourth and the fifth resistors have different resistances.

### BRIEF DESCRIPTION OF THE DRAWINGS

The above contents of the present invention will become more readily apparent to those ordinarily skilled in the art after reviewing the following detailed description and accompanying drawings, in which:

FIG. 1 illustrates pin configuration of a prior art optical mouse chip;

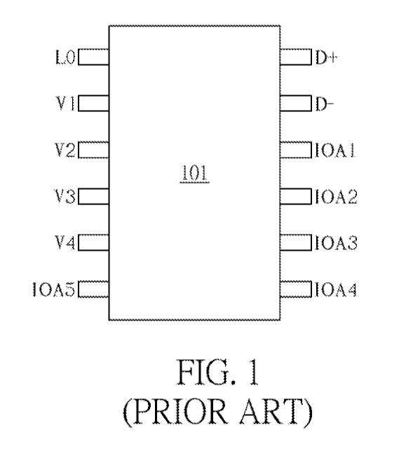

FIG. 2 illustrates an optical mouse according to an embodiment of the invention;

FIG. 3 illustrates an optical mouse SOC integrated in the structure of an optical mouse according to an embodiment of the invention;

FIG. 4 illustrates an optical mouse SOC integrated in the structure of an optical mouse according to another embodiment of the invention; and

FIG. 5 demonstrates operation principle of the embodiment in FIG. 4.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

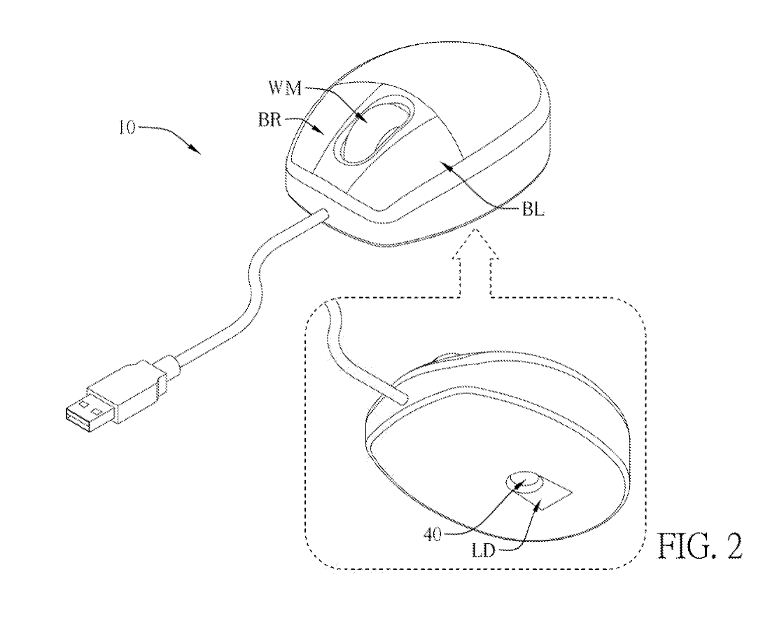

Please refer to FIG. 2 which illustrates an optical mouse 10 according to an embodiment of the invention. The optical mouse 10 has a plurality of buttons, such as a button BR (right button), a button BL (left button) and so on. The optical mouse 10 also includes a wheel WM. For optical locating, the optical mouse 10 has a light source LD and an optical sensing array 40 for detecting reflected light.

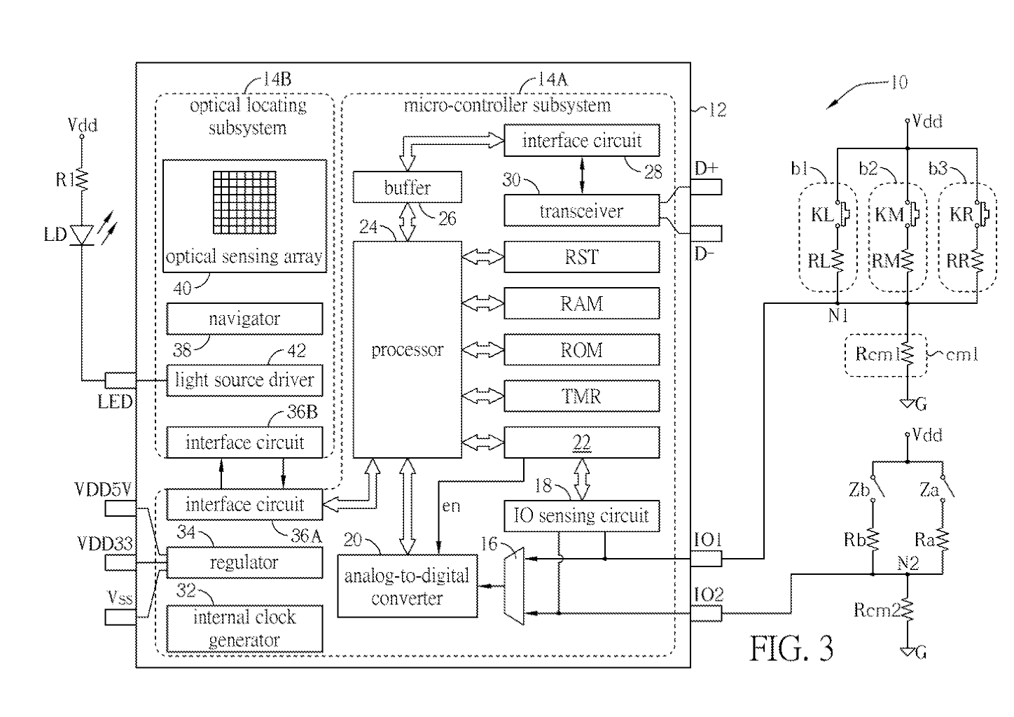

FIG. 3 illustrates an SOC 12 (an optical mouse SOC) installed in the optical mouse 10 according to one embodiment of the invention. The SOC 12 of the invention integrates a micro-controller subsystem 14A and an optical locating subsystem 14B. The micro-controller subsystem 14A includes a processor 24, a buffer 26, an interface circuit 28, a transceiver 30, an internal clock generator 32, a regulator 34, an interface circuit 36A, a reset controller RST, a random access memory RAM, a read-only memory ROM, a timer TMR and a power-interrupt controller 22. To implement the invention, the micro-subsystem 14A further includes a multiplexer 16, an IO sensing circuit 18 and an analog-to-digital converter 20. The optical locating subsystem 14B includes the optical sensing array 40, a light source driver 42, a navigator 38 and an interface circuit 36B.

The pin configuration of the SOC 12 includes power pins VDD5V, VDD33 and Vss, a driving pin LED, signal pins D+ and D−, and IO pins IO1 and IO2. The power pins VDD5V, VDD33 and Vss respectively couple to corresponding operation voltages, e.g., the power pins VDD5V and VDD33 couple to power voltages of 5V and 3.3V respectively, the power pin Vss couples to the ground voltage G. The power voltage of 5V, as a main power source of the optical mouse SOC 12, supplies the optical locating subsystem 14B and the micro-controller subsystem 14A. The power voltage of 3.3V supplies the transceiver 30 such that the differential signal of the signal pins D+ and D− has amplitude of 3.3V. The signal pins D+ and D− exchange data with the host (not shown); for example, the USB interface specification can be adopted for data exchange with the host.

In the optical locating subsystem 14B, the light source driver 42 controls the light source LD, such as a light emitting diode, through the driving pin LED and the resistor R1. When the optical sensing array 40 receives/senses reflected light from the light source LD, the navigator 38 compares sensed results to obtain displacement of the optical mouse 10 for optical locating. Through interface circuits 36A and 38B between the optical locating subsystem 14B and the micro-controller subsystem 14A, an optical location signal carrying results of optical locating can be sent back to the processor 24, and the processor 24 can control operation of the optical locating subsystem 14B.

In the micro-controller subsystem 14A, the processor 24 dominates controlling of the SOC 12, the read-only memory ROM and the random access memory RAM respectively support non-volatile memory resource and volatile memory resource of the processor 24. The reset controller RST controls reset of the SOC 12; the internal clock generator 32 and the timer TMR controls operation timing of the SOC 12. The regulator 34 regulates/adjusts power received through the power pins VDD5V, VDD33 and Vss and supplies power for the SOC 12. The power-interrupt controller 22 manages power modes and interrupt requests.

The structure of FIG. 3 includes a plurality of switches KL, KM, KR and Za, Zb. For example, the switches KL, KM and KR respectively correspond to left button, middle button and right button of the optical mouse 10, the wheel corresponds to the two switches Za and Zb, such that status of each switch reflects user touch control on corresponding button or wheel. The IO pin IO1 couples to the switches KL, KM and KR for receiving and distinguishing individual status of each of the three switches. Similarly, the IO pin IO2 couples to the switches Za and Zb. As a result, the pin configuration of the invention needs only two IO pins, and the total pin count of the SOC of the invention is reduced to eight to match an economic 8-pins package of lower cost.

In the embodiment of FIG. 3, each of the switches KL, KM and KR associated to the IO pin IO1 couples to the IO pin IO1 through a corresponding branch circuit, and controls, according to switch status, whether the corresponding branch circuit conducts a power voltage Vdd (such as the power voltage of the power pin VDD5V) to the IO pin IO1, and the branch circuits corresponding to these switches respectively have different resistances. For example, the switch KL and a resistor RL form a branch circuit b1 between the power voltage Vdd and a node N1. Similarly, the switches KM and a resistor RM, the switches KR and a resistor RR respectively form branch circuits b2 and b3, and the branch circuits b1 to b3 form a parallel circuit between the power voltage Vdd and the node N1. The resistances of the resistors RL, RM and RR are different so the branch circuits have different resistances. On the other hand, a resistor Rcm1 coupled between the node Ni and another power voltage G (e.g., the ground voltage coupled to the power pin Vss) can be considered as a common circuit cm1. For the IO pin IO1, as the switches KL,

KM and KR conducts or not, conducted branch circuits and the common circuit cm1 perform voltage-dividing at the IO pin IO1 (i.e., node N1).

For instance, if only the switch KL is touched to conduct, a voltage of the node N1 will be Vdd*Rcm1/(Rcm1+RL); if only the switch KR conducts, the voltage of the node N1 becomes Vdd*Rcm1/(Rcm1+RR). Because the resistors RL and RR are different (in resistance), which switch is triggered to conduct can be distinguished according to voltage magnitude of the node N1. Furthermore, when both the switches KL and KR are simultaneously triggered to conduct, the voltage of the node N1 is Vdd*Rcm1/(Rcm1+RL//RR) with RL//RL being the parallel resistance of the resistors RL and RR, thus the voltage is also distinguishable from that when only one switch conducts. If the switches KL and KM conduct at the same time, the voltage of the node N1 becomes Vdd*Rcm1/(Rcm1+RL//RM), which is different from the voltage when the switches KL and KR both conduct. Even when the switches KL, KR and KM all conduct at the same time, the voltage Vdd*Rcm1/(Rcm1+RL//RM//RR) of the node N1 can be distinguished from the voltage when one or two switches conduct. In other words, with the structure shown in FIG. 3, the invention can distinguish individual status of each of the switches KL, KM and KR according to the voltage of the IO pin IO1 (the node N1).

Based on the same principle, with switch Za/resistor Ra (a branch circuit), switch Zb/resistor Rb (another branch circuit) and a resistor Rcm2 (a common circuit) connected to a node N2, respective status of each of the switches Za and Zb can be distinguished according to a voltage of the IO pin IO2.

In the SOC 12 of the invention, the analog-to-digital 20 converts the voltages of the IO pins IO1 and IO2 to corresponding digital signals; as the digital signals are sent back to the processor 24, the processor 24 can execute a firmware to distinguish individual status of each switch. Because the embodiment applies two IO pins IO1 and IO2, the SOC 12 adopts a poll mechanism such that the IO pins IO1 and IO2 can share the same analog-to-digital converter 20; the multiplexer 16 in the SOC 20 implements this poll mechanism. The multiplexer 16 couples between the two IO pins IO1, IO2 and the analog-to-digital converter 20 for periodically conducting each of the two IO pins to the analog-to-digital converter 20 under control of a periodic clock. For example, when the periodic clock is of high level, the multiplexer 16 conducts the IO pin IO1 to the analog-to-digital converter 20, and when the periodic clock stay in low level, the multiplexer 16 conducts the IO pin IO2 to the analog-to-digital converter 20 instead. In this alternating way, the analog-to-digital converter 20 converts voltage signals of IO pins IO1 and IO2 to corresponding digital signals and sends them back to the processor 24 in turn, so the processor 24 can distinguish individual status of each of the switches coupled to each IO pin.

In SOC 12, the optional IO sensing circuit 18 couples to the two IO pins IO1 and IO2 for determining whether the signal of each IO pin is effective signal, if true, the IO sensing circuit 18 controls the SOC 12 to operate in a normal mode to further enable the analog-to-digital converter 20 through management of the power-interrupt controller 22. Otherwise, also through the power-interrupt controller 22, the IO sensing circuit 18 controls the SOC 12 to operate in a sleep mode for reducing power consumption. In the sleep mode, the power-interrupt controller 22 controls the analog-to-digital converter 20 to operate in a power-saving status or to stop operating, the periodic clock controlling the multiplexer 16 can be gated, functional blocks in the processor 24 for distinguishing switch status can also enter into sleep mode. For example, the IO sensing circuit 18 determines whether no effective touch control has been received from the switches coupled to the IO pins for a given duration according to whether the voltage signals of the IO pins do not exceed a threshold for a specific period; if so, and no new displacement has been detected by the optical mouse 10, as well as the signal information of the signal pins D+ and D− indicates the host is in power-saving status, it means the optical mouse 10 is idle, so the optical mouse 10 can enter into the sleep mode to reduce power consumption. On the contrary, when the IO sensing circuit 18 detects that the voltage signal of any of the IO pin exceeds the threshold, it implies that the optical mouse 10 is in use (by the user) again. So the IO sensing circuit 18 informs the power-interrupt controller 22 to return to the normal mode, then the power-interrupt controller 22 can use an enable signal en to enable the analog-to-digital converter 20, restore the periodic clock of the multiplexer 16, and enable the processor 24 for switch status distinguishing again. The aforementioned threshold can be decided according to the lowest voltage among voltages corresponding to all possible status combinations of all the switches of all the IO pins.

As the individual status of each of the switches is distinguished by the micro-controller subsystem 14A, the statuses of the switches and the locating result (the optical location signal) of the optical locating subsystem 14B can be transmitted to the host together. The buffer 26, the interface circuit 28 and the transceiver 30 implement data exchange between the host and the SOC 12. For example, USB interface specification can be adopted as the signal interface for communicating the host, thus the interface circuit 28 and the transceiver 30 are respectively a media access control circuit and a transceiver of USB specification for transmitting differential USB signal/packages through the signal pins D+ and D−.

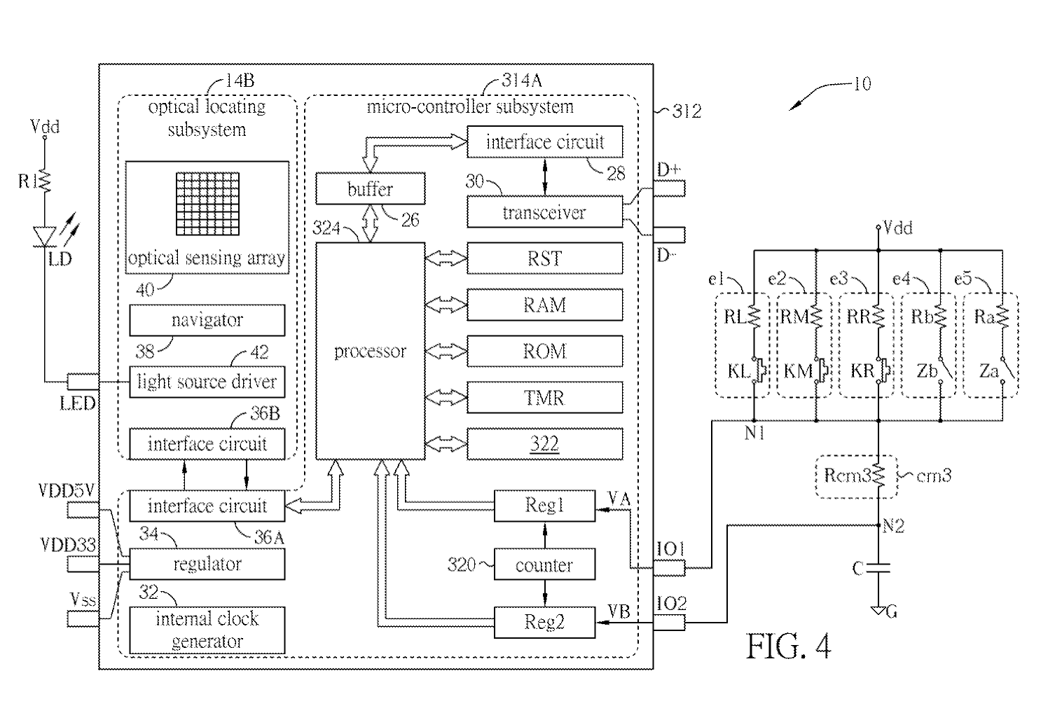

Please refer to FIG. 4, which illustrates an optical mouse SOC 312 integrated in the optical mouse 10 according to another embodiment of the invention. In FIG. 3 and FIG. 4, elements/blocks labeled with same numbers have same functions. In FIG. 4, a processor 324 dominates controlling of the SOC 312. The power-interrupt controller 322 manages power supplies and interrupts requests. The statuses of the switches and the locating result (as an optical position signal) of the optical locating subsystem 14B can be transmitted to the host (not shown) by the micro-controller subsystem 314A.

In the embodiment of FIG. 4, the SOC 312 of the invention also utilizes two IO pins IO1 and IO2 to cover all switches KL, KM, KR, Za and Zb of the optical mouse 10. Each of the switches couples between the power voltage Vdd and the IO pin IO1 through a corresponding branch circuit, such that each switch controls whether the power voltage Vdd conducts to the IO pin IO1 through the corresponding branch circuit according to switch status. The branch circuits corresponding to different switches have different resistances. For example, the switch KL and a resistor RL forms a branch circuit el coupled between the power voltage Vdd and the node N1 (the IO pin IO1); combinations of switch KM/resistor RM, switch KR/resistor RR, switch Za/resistor Ra and switch Zb/resistor Rb can be respectively regarded as branch circuits e2 to e5. The resistors in these branch circuits have different resistances so these branch circuits have different resistances. The IO pin IO2 couples to the IO pin IO1 through a common circuit cm3, and further couples to a common capacitor C, such that each of the switches controls, according to switch status, whether the power voltage Vdd conducts to the common capacitor C through the corresponding branch circuit and the common circuit cm3 for charging the common capacitor C. In the embodiment of FIG. 4, the common circuit cm3 includes a resistor Rcm3.

While above circuit structure works, if only the switch KL is triggered to conduct, the power voltage Vdd charges the common capacitor C through a serial resistor combination (RL+Rcm3), so a time constant related to a resistance-capacitance product of the resistor RL and the common capacitor C has an effect on voltage transition speed (e.g., rising speed) of the node N2. Because different switch corresponds to different resistance, voltage transition speed of the node N2 will be different when different switch conducts. Furthermore, even multiple switches simultaneously conducts, voltage transition speed varies as well. For example, if the switches KL and KM conduct at the same time, the power voltage Vdd charges the common capacitor C through a resistor combination (RL//RM+Rcm3). As different switches simultaneous conduct, the resistors in different branch circuits are shunt to cause different voltage transition speed of the node N2. According to charging speed (time constant) of the resistor-capacitor network shown in FIG. 4, individual status of each switch can be distinguished.

To implement aforementioned concept, the SOC 312 of the invention further includes a counter 320 and two input capture registers Reg1 and Reg2. The counter 320 provides a count varying with time. The input capture register Reg1 coupled to the IO pin IO1 for capturing the count of the counter 320 according to signal (voltage) transition of the IO pin IO1; the second input capture register Reg 2 coupled to the IO pin IO2 for capturing the count of the counter according to signal (voltage) transition of the IO pin IO2. According to the counts captured by the input capture register Reg1 and Reg2, time difference between signal transitions of the IO pins IO1 and IO2 can be obtained for distinguishing individual status of each switch.

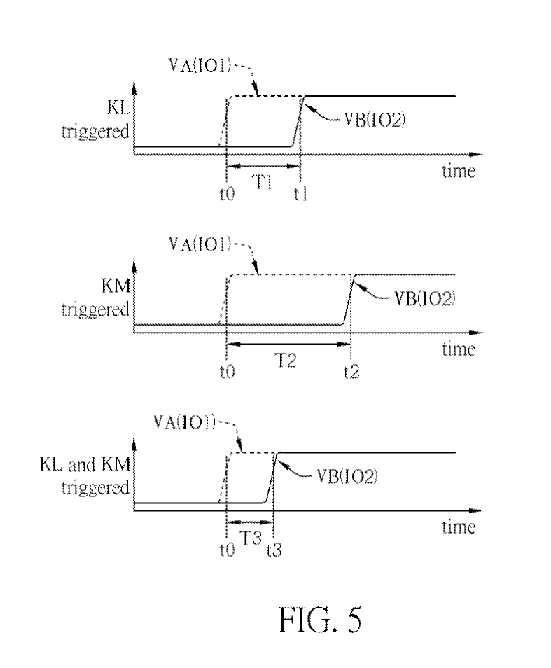

Please refer to FIG. 5, which demonstrates the principle of distinguishing switch status by voltage signal waveforms of the IO pins IO1 and IO2; the transverse axis and the longitudinal axis of each waveform represent time and magnitude, respectively. The waveform shown in dash-line represents voltage signal VA of the IO pin IO1, waveform shown in solid-line is voltage signal VB of the IO pin IO2. For example, assuming only the switch KL is triggered to conduct among all switches; when the switch KL is triggered near time t0, the voltage signal VA of the IO pin IO1 rapidly transits (rises) at time t0 because the power voltage Vdd conducts to the IO pin IO1 though the resistor RL directly (FIG. 4). On the other hand, the voltage signal VB of the IO pin IO2 delays to response at time t1 when the common capacitor C is charged enough to cause a signal transition; so the time difference T1 between time t0 and time t1 relates to resistance of the resistor combination (RL+Rcm3).

Similarly, if only the switch KM is triggered at time t0, the voltage signal VA changes rapidly too, while the voltage VB of the IO pin IO2 delays to response at time t2. The time difference T2 between time t0 and time t2 relates to resistor combination (RM+Rcm3); if the resistance of the resistor RM is greater than that of the resistor RL, the time difference T2 is longer than the time difference T1.

On the other hand, if the switches KM and KL are triggered to conduct at time t0 simultaneously, the voltage signal VA still transits rapidly, and the transition of the voltage signal VB follows later at time t3. Because the power voltage Vdd charges the common capacitor C through a resistor combination (RM//RL+Rcm3) of lower resistance, the time difference T3 between the time t0 and the time t3 is shorter than the time differences T1 and T2.

In other words, by comparing time differences between signal transitions of IO pins IO1 and IO2, individual status of each switch can be distinguished. In FIG. 4, the input capture registers Reg1 and Reg2 are designed to respectively capture signal transition times (measured in counts) of the IO pins IO1 and IO2, so the processor 324 can calculate time difference between signal transitions and then resolve individual status of each switch.

To sum up, with capability of distinguishing respective statuses of multiple switches coupled to a same IO pin, the invention can integrate the optical locating subsystem and the micro-controller subsystem into a single optical mouse SOC of 8-pins for effective pin count optimization and cost reduction of packaging, which leads to SOC and optical mouse of lower cost. In the preferred embodiments shown in FIG. 3 and FIG. 4, two IO pins (such as General Purpose Input/Output pins, GPIO pins) are utilized to distinguish individual status of each of five (or more) switches, so the total pin count of the SOC of the invention can be optimized to eight pins. In the embodiments of FIG. 3 and FIG. 4, each of the branch circuits and common circuits has only one resistor, but the invention is not so limited; passive elements and/or active elements which introduce different impedance to each branch circuit can be adopted to construct the branch circuits and/or the common circuits.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical mouse SOC with 8-pins applied to an optical mouse which comprises a plurality of switches for receiving touch control, the optical mouse SOC comprising:
a micro-controller subsystem;
an optical locating subsystem providing an optical location signal to the micro-controller subsystem;
a first power pin coupled to a first power voltage, for supplying the optical locating subsystem and the micro-controller subsystem;
a second power pin coupled to a second power voltage supplying the optical locating subsystem and the micro-controller subsystem;
a driving pin coupled to the optical locating subsystem for controlling a light source;
two signal pins coupled to the micro-controller subsystem for providing a differential signal, with an amplitude of the second power voltage, to a host; and
a first IO pin coupled to a predetermined number of the plurality of switches such that the micro-controller subsystem detects statuses of the predetermined number of the plurality of switches.

2. The optical mouse SOC of claim 1, wherein the first IO pin is coupled to three of the plurality of switches.

3. The optical mouse SOC of claim 1 further comprising:
a third power pin coupled to a third power voltage supplying the micro-controller subsystem.

4. The optical mouse SOC of claim 1, wherein the mouse further comprises a wheel, a status of the wheel are associated to one of the plurality of switches.

5. The optical mouse SOC of claim 1, wherein the optical mouse further comprises a plurality of buttons with each of the buttons associated to one of the plurality of switches.

6. The optical mouse SOC of claim 1 further comprising:
a second IO pins coupled to a second predetermined number of the plurality of switches such that the micro-controller subsystem detects statuses of the second predetermined number of the plurality of switches.

7. The optical mouse SOC of claim 6, wherein the micro-controller subsystem comprises:
a processor for controlling operation of the optical mouse SOC; and
an analog-to-digital converter for converting signals of the first and second IO pins to corresponding digital signals such that the processor distinguishes individual status of each of the plurality of switches according to each of the first and second IO pins.

8. The optical mouse SOC of claim 7 further comprising:
a multiplexer coupled between the first and second IO pins and the analog-to-digital converter for respectively conducting each of the first and second IO pins to the analog-to-digital converter periodically.

9. The optical mouse SOC of claim 7 further comprising:
an IO sensing circuit coupled to the first and second IO pins for determining whether a signal of each of the first and second IO pins is effective, if true, the IO sensing circuit controls the optical mouse SOC to operate in a normal mode to further enable the analog-to-digital converter; otherwise the IO sensing circuit controls the optical mouse SOC to operate in a sleep mode such that the analog-to-digital converter operates in a power-saving status or stops to operate.

10. The optical mouse SOC of claim 1, wherein each of the switches associated to the first IO pin couples to a corresponding branch circuit and controls, according to switch status, whether the corresponding branch circuit conducts the first power voltage to the first IO pin; wherein the branch circuits corresponding to the plurality of switches respectively have different resistances, such that the processor distinguishes statuses of the plurality of switches according to signal magnitudes of the first IO pin.

11. The optical mouse SOC of claim 10, wherein the first IO pin further couples to the second power voltage through a common circuit, the common circuit has a resistance such that the common circuit and the branch circuit that conducts the first IO pin will perform voltage-dividing at the first IO pin.

12. The optical mouse SOC of claim 1 further comprising a second IO pin, wherein each of the plurality of switches couples between the first power voltage and the first IO pin through a corresponding branch circuit; the branch circuits corresponding to the plurality of switches have different resistances, such that each of the plurality of switches controls, according to switch status, whether the first power voltage conducts to the first IO pin through the corresponding branch circuit; wherein the second IO pin couples to the first IO pin through a common circuit, and further couples to a common capacitor, such that each of the plurality of switches controls, according to switch status, whether the first power voltage conducts to the common capacitor through the corresponding branch circuit and the common circuit for charging the common capacitor.

13. The optical mouse SOC of claim 12 further comprising:
a counter for providing a count varying with time;
a first input capture register coupled to the first IO pin for capturing the count of the counter according to signal transition of the first IO pin; and
a second input capture register coupled to the second IO pin for capturing the count of the counter according to signal transition of the second IO pin such that optical mouse SOC calculates time difference between signal transitions of the first IO pin and the second IO pin according to the counts captured by the first input capture register and the second input capture register for distinguishing statuses of the plurality of switches.

14. An optical mouse SOC with 8-pins applied to an optical mouse which comprises a left button switch, a middle button switch, a right button switch, a first wheel switch and a second wheel switch for receiving touch control, the optical mouse SOC comprising:
a micro-controller subsystem;
an optical locating subsystem providing an optical location signal to the micro-controller subsystem;
a first power pin coupled to a first power voltage supplying the optical locating subsystem and the micro-controller subsystem;
a second power pin coupled to a second power voltage supplying the micro-controller subsystem;
a driving pin coupled to the optical locating subsystem for controlling a light source;
two signal pins coupled to the micro-controller subsystem for providing a differential signal, with an amplitude swinging between the first power voltage and the second power voltage, to a host; and
a first IO pin with a first parallel circuit connected between the first IO pin and the first power voltage; and
wherein the first parallel circuit comprises a first resistor serial to the left button switch, a second resistor serial to the middle button switch, and a third resistor serial to the right button switch; the first resistor, the second resistor and the third resistor have different resistances.

15. The optical mouse SOC of claim 14 further comprising a third power pin coupled to a third voltage supplying the optical locating subsystem and the micro-controller subsystem.

16. The optical mouse SOC of claim 14 further comprising a second IO pin with a second parallel circuit connected between the second IO pin and the first power voltage, and with a second common resistor connected between the second IO pin and the ground voltage; wherein the second parallel circuit comprises a fourth resistor serial to the first wheel switch and a fifth resistor serial to the second wheel switch; the fourth resistor and the fifth resistor have different resistances.

17. The optical mouse SOC of claim 16, wherein the micro-controller subsystem comprises:
a processor controlling operation of the optical mouse SOC; and
an analog-to-digital converter for converting signals of the first IO pin and the second IO pin to corresponding digital signals such that the processor distinguishes individual status of the left button switch, the middle button switch, the right button switch, the first wheel switch and the second wheel switch according to each of the first IO pin and the second IO pin.

18. The optical mouse SOC of claim 17 further comprising:
a multiplexer coupled between the first IO pin, the second IO pin and the analog-to-digital converter for periodically conducting the first IO pin and the second IO pin to the analog-to-digital converter.

19. The optical mouse SOC of claim 17 further comprising:
an IO sensing circuit coupled to the first IO pin and the second IO pin for determining whether a signal of each of the first IO pin and the second IO pin is effective, if true, the IO sensing circuit controls the optical mouse SOC to operate in a normal mode to further enable the analog-to-digital converter; otherwise the IO sensing circuit controls the optical mouse SOC to operate in a sleep mode such that the analog-to-digital converter operates in a power-saving status or stops to operate.

20. An optical mouse SOC with 8-pins, applied to an optical mouse which comprises a left button switch, a middle button switch, a right button switch, a first wheel switch and a second wheel switch for receiving touch control, the optical mouse SOC comprising:
a micro-controller subsystem;
an optical locating subsystem providing an optical location signal to the micro-controller subsystem;
a first power pin coupled to a first power voltage supplying the optical locating subsystem and the micro-controller subsystem;
a second power pin coupled to a second power voltage supplying the micro-controller subsystem;
a third power pin coupled to a ground voltage supplying the optical locating subsystem and the micro-controller subsystem;
a driving pin coupled to the optical locating subsystem for controlling a light source;
two signal pins coupled to the micro-controller subsystem for providing a differential signal, with an amplitude of the second power voltage, to a host;
a first IO pin with a parallel circuit connected between the first IO pin and the first power voltage; and
a second IO pin with a common resistor connected between the second IO pin and the first IO pin, and with a common capacitor connected between the second IO pin and the ground voltage;
wherein the parallel circuit comprises a first resistor serial to the left button switch, a second resistor serial to the middle button switch, a third resistor serial to the right button switch, a fourth resistor serial to the first wheel switch and a fifth resistor serial to the second wheel switch; the first resistor, the second resistor, the third resistor, the fourth and the fifth resistors have different resistances.

21. The optical mouse SOC of claim 20, wherein the left button switch, the middle button switch, the right button switch, the first wheel switch and the second wheel switch control, according to switch statuses, whether the first power voltage conducts to common capacitor through the first IO pin and the second IO pin for charging the common capacitor respectively through the common resistor and one or more of the first resistor, the second resistor, the third resistor, the fourth resistor and the fifth resistor.

22. The optical mouse SOC of claim 21 further comprising:
a counter providing a count varying with time;
a first input capture register coupled to the first IO pin for capturing the count of the counter according to signal transition of the first IO pin; and
a second input capture register coupled to the second IO pin for capturing the count of the counter according to signal transition of the second IO pin; such that optical mouse SOC calculates time difference between signal transitions of the first IO pin and the second IO pin according to the counts captured by the first input capture register and the second input capture register for distinguishing statuses of the left button switch, the middle button switch, the right button switch, the first wheel switch and the second wheel switch.
